(19) United States
(12) Patent Application Publication
(10) Pub. No.: US 2012/0128542 A1
(43) Pub. Date: May 24, 2012

(54) Apparatus and Method of Manufacturing Polysilicon

(76) Inventor: Doo Jin PARK, Yongin-si (KR)

(21) Appl. No.: 13/363,899

(22) Filed: Feb. 1, 2012

Related U.S. Application Data
(62) Division of application No. 12/563,217, filed on Sep. 21, 2009.

(30) Foreign Application Priority Data
Apr. 6, 2009 (KR) 10-2009-0029527

(51) Int. Cl. B01J 19/08; B01J 19/26

(52) U.S. Cl. 422/186

(57) ABSTRACT

An apparatus and method of manufacturing polysilicon is disclosed, which is capable of shortening a time period required for manufacturing polysilicon by depositing polysilicon grains through a pyrolysis of silane gas by using a laser beam, and is capable of manufacturing an ingot by directly depositing polysilicon grains and melting the polysilicon grains without using an additional crystal seed, wherein the apparatus comprising a reaction chamber; a gas supplier for supplying a silane gas to the reaction chamber; a laser irradiator for generating polysilicon grains through a pyrolysis of the silane gas by irradiating with a laser beam the silane gas supplied from the gas supplier; and a polysilicon-grain receiver for receiving and storing the polysilicon grains.

### CROSS REFERENCE TO RELATED APPLICATIONS

This application is a divisional of U.S. patent application Ser. No. 12/563,217 (Attorney Docket No. OP09-ZZ-007-US-00), filed Sep. 21, 2009, pending, and claims the benefit of Korean Patent Application No. P2009-0029527, filed on Apr. 6, 2009, each of which is hereby incorporated by reference as if fully set forth herein.

### BACKGROUND OF THE INVENTION

1. Field of the Invention

The present invention relates to polysilicon, and more particularly, to an apparatus and method of manufacturing polysilicon through the use of laser.

2. Discussion of the Related Art

Recently, polysilicon is widely used in various fields related with a semiconductor device and a solar cell since the polysilicon is in a multi-crystalline status and has a high degree of purity.

A typical method of manufacturing polysilicon will be explained as follows.

First, silicon dioxide/quartz sand (main component: SiO₂) and graphite (main component: C) react in an arc discharge furnace, to thereby manufacture approximate 99% metallurgical Si (MG-Si).

Through a gasifying procedure using the MG-Si as a starter, a silane material is mixed, separated and purified so as to manufacture a gaseous silane material with high purity. The manufactured silane gas with high purity may be trichlorosilane (TCS) gas expressed as a chemical formula SiHCl₃, or may be monosilane (MS) gas expressed as a chemical formula SiH₄.

The TCS gas may be obtained by reacting the MG-Si with HCl, and the monosilane gas may be obtained by reacting the MG-Si with SiCl₄ and H₂, or reacting the MG-Si with SiF₄ and NaAlH₄.

Accordingly, as a chemical vapor deposition is applied to the silane gas with high purity, silicon is deposited so that polysilicon of a solid statue is manufactured. In this case, Si minute particles are generated from the silane gas through hydrogen reduction and thermal decomposition under a high-temperature circumstance. The generated Si minute particles are deposited on a surface of crystal seed, thereby obtaining multi-crystalline polysilicon.

Hereinafter, a related art method of manufacturing polysilicon of solid status through the use of silane gas will be explained with reference to FIG. 1.

FIG. 1 is a schematic view illustrating a related art apparatus of manufacturing polysilicon, which is capable of manufacturing polysilicon from the silane gas through the use of a bell-jar reactor 10. A related art method of manufacturing polysilicon through the use of apparatus shown in FIG. 1 will be explained as follows.

First, Si core filament 20 having a fineness of 6 mm to 7 mm is positioned in a reverse U shape inside the bell-jar reactor 10, and an end of the Si core filament 20 is connected to an electrode 30. Then, a preheating procedure is performed through the use of pre-heater, whereby the bell-jar reactor 10 is preheated above 300° C. Thus, the Si core filament 20 is lowered in its resistivity, so that the lower resistivity of Si core filament 20 enables electric resistance heating. By supplying electricity with a predetermined electric potential through the electrode 300, the Si core filament 20 is heated at a high temperature, and a reaction gas including both silane gas and hydrogen gas is supplied to the inside of the bell-jar reactor 10. Accordingly, as Si minute particles are deposited on the surface of Si core filament 20, the Si core filament 20 is increased in its fineness. Then, electric resistance heating and Si depositing procedures are performed for several days to several ten days, to thereby obtain a bar-type polysilicon product having a diameter of about 10 cm to 15 cm.

However, the related art method has the following disadvantages caused by limitations of the Si-depositing method using decomposition of the silane gas through the electric resistance heating.

For smoothly depositing the Si minute particles by decomposition of the silane gas through the use of electric resistance heating, the inside of the bell-jar reactor 10 has to be maintained at a temperature above 1000° C. Thus, an initial installment cost is immense due to the large load of electric heating and power consumption.

Since the Si minute particles are deposited by decomposition of the silane gas through the use of electric resistance heating, it may require a long period for manufacturing the polysilicon according to a desired size of the polysilicon product, for example, several ten days or more, thereby lowering the yield.

### SUMMARY OF THE INVENTION

Accordingly, the present invention is directed to provide an apparatus and method of manufacturing polysilicon that substantially obviates one or more problems due to limitations and disadvantages of the related art.

An aspect of the present invention is to provide an apparatus and method of manufacturing polysilicon, which is capable of decreasing power consumption by reducing a load of electric heating, and is also capable of shortening a time period required for manufacturing polysilicon in comparison to the related art.

To achieve these and other advantages and in accordance with the purpose of the invention, as embodied and broadly described herein, an apparatus of manufacturing polysilicon comprises a reaction chamber; a gas supplier for supplying a silane gas to the reaction chamber; a laser irradiator for generating polysilicon grains through a pyrolysis of the silane gas by irradiating with a laser beam the silane gas supplied from the gas supplier; and a polysilicon-grain receiver for receiving and storing the polysilicon grains.

In another aspect of the present invention, an apparatus of manufacturing polysilicon comprises a reaction chamber; a gas supplier for supplying silane gas to the reaction chamber; a laser irradiator for generating polysilicon grains through a pyrolysis of the silane gas by irradiating with a laser beam the silane gas supplied from the gas supplier; and an ingot forming part for receiving and storing the polysilicon grains, and forming an ingot by melting the stored polysilicon grains.

In another aspect of the present invention, a method of manufacturing polysilicon comprises supplying a silane gas to a reaction chamber by a gas supplier; generating polysilicon grains through a pyrolysis of the silane gas by irradiating with a laser beam the reaction chamber; and receiving and storing the polysilicon grains in a polysilicon-grain receiver.

In another aspect of the present invention, a method of manufacturing polysilicon comprises supplying a silane gas to a reaction chamber by a gas supplier; generating polysilicon grains through a pyrolysis of the silane gas by irradiating with a laser beam the reaction chamber; and receiving and storing the polysilicon grains in an ingot forming part, and forming an ingot by melting the polysilicon grains stored in the ingot forming part.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a related art apparatus of manufacturing polysilicon;

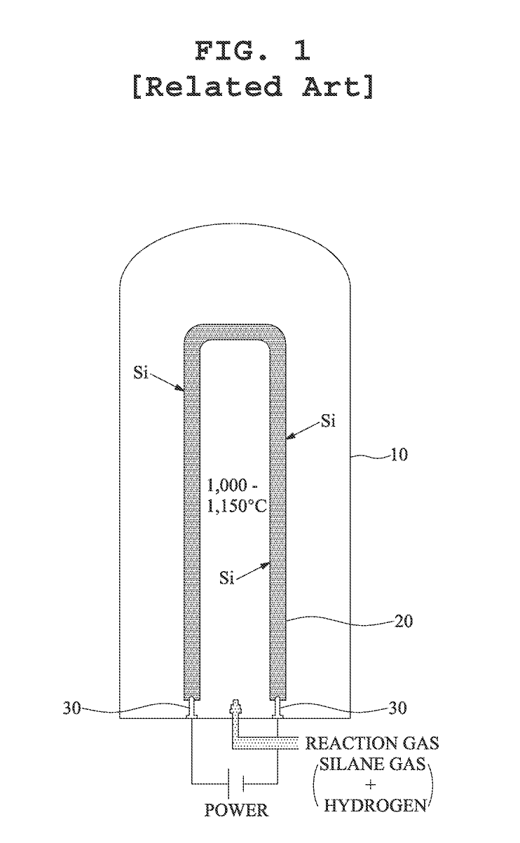

FIG. 2 is a schematic view illustrating an apparatus of manufacturing polysilicon according to one embodiment of the present invention; and

FIG. 3 is a schematic view illustrating an apparatus of manufacturing polysilicon according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, an apparatus and method of manufacturing polysilicon according to the present invention will be explained with reference to the accompanying drawings.

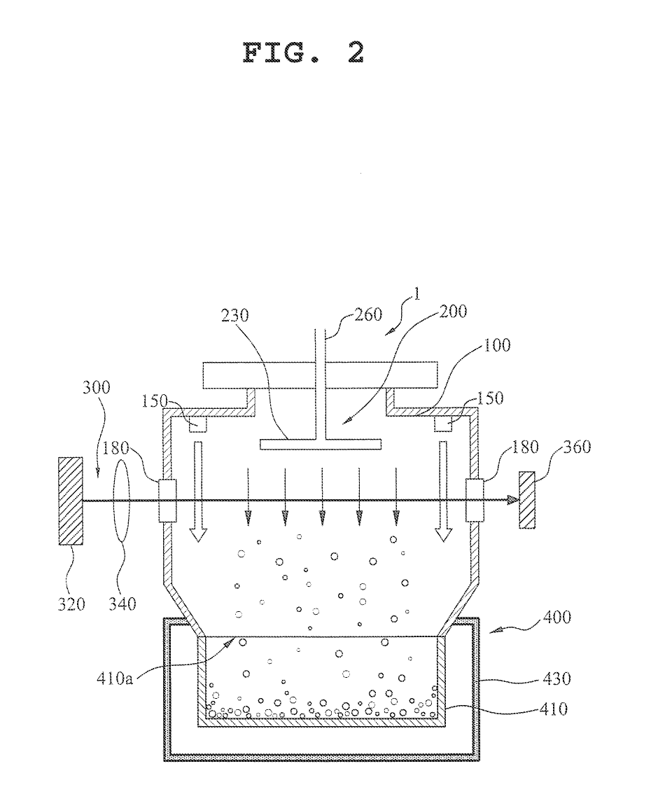

FIG. 2 is a schematic view illustrating an apparatus of manufacturing polysilicon according to one embodiment of the present invention.

As shown in FIG. 2, the apparatus 1 according to one embodiment of the present invention includes a reaction chamber 100, a gas supplier 200, a laser irradiator 300, and a polysilicon-grain receiver 400.

The reaction chamber 100 is a reaction space in which polysilicon grains are deposited by pyrolysis of a silane gas. Although not shown, a vacuum pump may be connected to the reaction chamber 100 so as to maintain the inside of the reaction chamber 100 as a vacuum state; and an exhaust apparatus may be connected to the reaction chamber 100 so as to exhaust the reaction chamber 100 of a reaction gas.

The gas supplier 200 supplies the silane gas such as trichlorosilane (TCS) gas or monosilane (MS) gas to the reaction chamber 100. The gas supplier 200 is provided at an upper portion of the reaction chamber 100. The gas supplier 200 is comprised of a gas supplying nozzle 230 and a gas supplying pipe 260, wherein the gas supplying nozzle 230 is positioned inside the reaction chamber 100, and the gas supplying pipe 260 is extended to the exterior of the reaction chamber 100 while being in communication with the gas supplying nozzle 230. Although not shown, an end of the gas supplying pipe 260 is connected to a gas supplying tank which stores the silane gas therein.

After the silane gas stored in the gas supplying tank moves to the gas supplying nozzle 230 through the gas supplying pipe 260, the silane gas is supplied from the gas supplying nozzle 230 to the inside of the reaction chamber 100. Also, an air curtain generator 150 is additionally provided in the reaction chamber 100, wherein the air curtain generator 150 prevents the silane gas from being in contact with an inner lateral surface of the reaction chamber 100 when the supplied silane gas moves from an upper portion of the reaction chamber 100 toward a lower portion of the reaction chamber 100. That is, the air curtain generator 150 generates an air curtain by spraying a gas such as argon (Ar) at a direction from an upper lateral side of the reaction chamber 100 to a lower lateral side of the reaction chamber 100, to thereby prevent the silane gas from being in contact with the inner lateral surface of the reaction chamber 100.

Accordingly, as the silane gas supplied from the gas supplier 200 is irradiated with the laser beam from the laser irradiator 300, the polysilicon grains are deposited by the pyrolysis of silane gas. The laser beam irradiated from the laser irradiator 300 proceeds from one side of the reaction chamber 100 to the other side of the reaction chamber 100, whereby a large amount of silane gas can be pyrolyzed in a short time period. That is, a portion between the gas supplier 200 and the polysilicon-grain receiver 400 is irradiated with the laser beam proceeding from one side of the reaction chamber 100 to the other side of the reaction chamber 100, thereby carrying out the pyrolysis of silane gas.

The silane gas supplied from the gas supplier 200 falls down toward the lower portion of the reaction chamber 100 from the upper portion of the reaction chamber 100. In this case, if the portion between the gas supplier 200 and the polysilicon-grain receiver 400 is irradiated with the laser beam, a contact area is increased between the laser beam and the silane gas, whereby a large amount of silane gas can be pyrolyzed in a short time period.

The laser irradiator 300 may be formed of an infrared-ray laser irradiator, for example, CO₂ laser irradiator. The laser irradiator 300 is comprised of a laser oscillator 320, an optical system 340, and a laser power receiver 360. The laser oscillator 320 oscillates the laser beam; the optical system 340 enhances uniformity of the oscillated laser beam; and the laser power receiver 360 receives the laser beam. The laser oscillator 320 and the optical system 340 are positioned at one external side of the reaction chamber 100; and the laser power receiver 360 is positioned at the other external side of the reaction chamber 100.

Since the laser irradiator 300 is positioned outside the reaction chamber 100, a window 180 is provided at a predetermined portion of the reaction chamber 100 so that the irradiated laser beam is transmitted to the inside of the reaction chamber 100 through the window 180. The window 180 is made of a material which is capable of transmitting light, for example, quartz or ZnSe. The entire reaction chamber 100 may be made of the material which is capable of transmitting light, for example, quartz or ZnSe.

The polysilicon-grain receiver 400 receives and stores the deposited polysilicon grains obtained by the pyrolysis of silane gas. As the polysilicon-grain receiver 400 is provided beneath the reaction chamber 100, the polysilicon-grain receiver 400 receives and stores the falling polysilicon grains.

The polysilicon-grain receiver 400 may be comprised of a container 410 and a supplementary chamber 430. The container 410 is in communication with the reaction chamber 100 through an opening 410a so that the polysilicon grains generated in the reaction chamber 100 smoothly advance toward the inside of the container 410 through the opening 410a. The polysilicon grains may be melted in an additional furnace, and then may be manufactured in an ingot type. For this, the container 410 with the polysilicon grains stored therein has to be transferred to the additional furnace. Thus, the container 410 may be detachably provided in the reaction chamber 100.

If oxygen penetrates into the inside of the container 410 when transferring the container 410 to the additional furnace, the polysilicon grains stored in the container 410 may be oxidized. In this respect, a sealing process is necessarily required for sealing the opening 410a of the container 410 after detaching the container 410 from the reaction chamber 100. In addition, the process of sealing the opening 410a of the container 410 has to be performed under such circumstance that the oxygen is not present in the container 410. For this, the supplementary chamber 430 is provided in such a way that the supplementary chamber 430 surrounds the container 410. Thus, after the container 410 is detached from the reaction chamber 100, the sealing process for sealing the opening 410a of the container 410 is performed in the supplementary chamber 430 surrounding the container 410, so that it is possible to prevent the oxygen from penetrating into the inside of the container 410.

A method of manufacturing polysilicon through the use of apparatus shown in FIG. 2 according to one embodiment of the present invention will be explained as follows.

First, the silane gas such as TCS gas or MS gas is supplied to the inside of the reaction chamber 100 through the gas supplying nozzle 230 of the gas supplier 200. At this time, the reaction chamber 100 may be maintained at an internal pressure of several mTorr to several hundred Torr.

When supplying the silane gas, a gas such as argon (Ar) is simultaneously sprayed from the air curtain generator 150 so as to generate the air curtain at the inner lateral surface of the reaction chamber 100, to thereby prevent the supplied silane gas from being in contact with the inner lateral surface of the reaction chamber 100.

Accordingly, as the reaction chamber 100 is irradiated with the laser beam by the laser irradiator 300, the polysilicon grains are generated by the pyrolysis of silane gas.

At this time, the portion between the gas supplier 200 and the polysilicon-grain receiver 400 is irradiated with the laser beam which advances from one side of the reaction chamber 100 to the other side of the reaction chamber 100, whereby the polysilicon grains can be deposited by pyrolyzing the large amount of silane gas in the short time period.

The process of supplying the silane gas may be performed concurrently with the irradiation process of the laser beam, or any one process of these two processes may be performed prior to the other process.

Then, the polysilicon-grain receiver 400 receives and stores the polysilicon grains therein. In more detail, the polysilicon grains are received and stored in the container 410 through the opening 410a being in communication with the reaction chamber 100. After the container 410 is detached from the reaction chamber 100, the sealing process for sealing the opening 410a may be performed inside the supplementary chamber 430 surrounding the container 410, and then the sealed container 410 may be transferred to the additional furnace, to thereby manufacture the ingot type polysilicon.

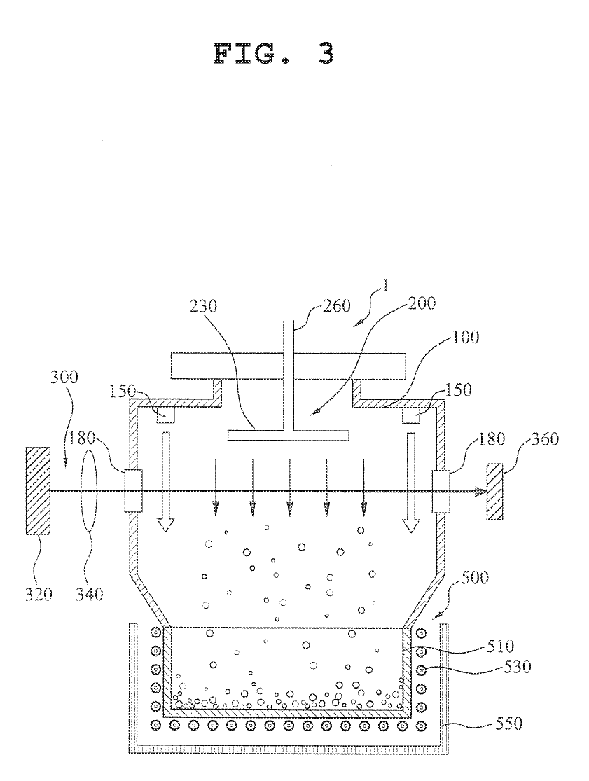

FIG. 3 is a schematic view illustrating an apparatus of manufacturing polysilicon according to another embodiment of the present invention.

The apparatus of FIG. 3 is identical in structure to the apparatus of FIG. 2 except that an ingot forming part 500 is provided instead of the polysilicon-grain receiver 400. Wherever possible, the same reference numbers will be used throughout the drawings to refer to the same or like parts as those of the aforementioned embodiment, and the detailed explanation for the same or like parts will be omitted.

As shown in FIG. 3, the apparatus of manufacturing polysilicon according to another embodiment of the present invention is comprised of a reaction chamber 100, a gas supplier 200, a laser irradiator 300, and the ingot forming part 500.

The ingot forming part 500 is provided beneath the reaction chamber 100. Thus, the ingot forming part 500 receives and stores falling polysilicon grains, and also forms an ingot by melting the received polysilicon grains.

The ingot forming part 500 is comprised of a furnace 510 and a plurality of heaters 530. The furnace 510 is a space for storing the falling polysilicon grains and melting the stored polysilicon grains. Also, the heaters 530 are provided to heat the furnace 510, wherein the heaters 530 may be formed in a line-type heater. An insulator 550 may surround the plurality of heaters 530. For taking out the polysilicon grains of the ingot type, the ingot forming part 500 may be detachably provided in the reaction chamber 100.

A method of manufacturing polysilicon through the use of apparatus shown in FIG. 3 according to another embodiment of the present invention will be explained as follows, wherein the detailed explanation for the same or like parts as those of the aforementioned embodiment will be omitted.

First, silane gas such as TCS gas or MS gas is supplied to the inside of the reaction chamber 100 through a gas supplying nozzle 230 of the gas supplier 200.

According as the reaction chamber 100 is irradiated with laser beam by the laser irradiator 300, the polysilicon grains are generated by the pyrolysis of silane gas.

At this time, the portion between the gas supplier 200 and the ingot forming part 500 is irradiated with the laser beam which advances from one side of the reaction chamber 100 to the other side of the reaction chamber 100, whereby the polysilicon grains can be deposited by pyrolyzing a large amount of silane gas in a short time period.

Next, the polysilicon grains are received and stored in the ingot forming part 500, and then the stored polysilicon grains are melted by the ingot forming part 500, thereby forming the ingot of polysilicon grains. At this time, the furnace 510 may be heated to a temperature of about 1000° C. to 1200° C. through the use of heaters 530.

Accordingly, the apparatus and method of manufacturing polysilicon according to the present invention has the following advantages.

In comparison to the related art, the apparatus and method of manufacturing polysilicon according to the present invention is more advantageous in that it generates the polysilicon grains by pyrolyzing the silane gas through the laser beam irradiation within a relatively shorter time period than that of the related art.

Particularly, the laser has selectivity for a raw material gas since the laser is a single wavelength light, and the laser is a high-energy beam which is capable of easily realizing a decomposition of the raw material gas by a multi-photon absorption in a short time period. The apparatus and method of manufacturing polysilicon according to the present invention deposits the polysilicon grains by the pyrolysis of silane gas through the laser beam having the aforementioned properties. Thus, the method according to the present invention, which uses the laser beam, can shorten the time period for depositing the polysilicon grains as compared to the related art method using the electric resistance heating for the decomposition of silane gas.

Especially, as the laser beam is irradiated to proceed from one side of the reaction chamber 100 to the other side of the reaction chamber 100, the contact area is increased between the laser beam and the silane gas widely supplied to the reaction chamber 100 from the gas supplier 200, whereby the large amount of silane gas can be pyrolyzed in the short time period.

Unlike the related art method which deposits the polysilicon grains on a surface of crystal seed, the method according to the present invention directly deposits the polysilicon grains without using the crystal seed, and manufactures the ingot by melting the deposited polysilicon grains. Thus, the method according to the present invention is advantageous in that there is no requirement for additionally manufacturing the seed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for manufacturing polysilicon, comprising:
a reaction chamber;
a gas supplier for supplying a silane gas to the reaction chamber;
a laser irradiator for generating polysilicon grains through a pyrolysis of the silane gas by irradiating with a laser beam the silane gas supplied from the gas supplier; and
a polysilicon-grain receiver for receiving and storing the polysilicon grains, comprising
a detachable container in communication with the reaction chamber through an opening so that the polysilicon grains generated in the reaction chamber smoothly advance toward an inside of the container, and
a supplementary chamber connected to the reaction chamber so that the supplementary chamber surrounds the container and prevents oxygen from penetrating into the container after detaching the container from the reaction chamber.

2. The apparatus of claim 1, wherein the laser beam irradiates a portion between the gas supplier and the polysilicon-grain receiver by advancing the laser beam from one side of the reaction chamber to another side of the reaction chamber.

3. The apparatus of claim 1, wherein the gas supplier is at an upper portion of the reaction chamber.

4. The apparatus of claim 1, further comprising:
an air curtain generator in the reaction chamber for preventing the silane gas supplied from the gas supplier from contacting an inner lateral surface of the reaction chamber.

5. The apparatus of claim 4, wherein the air curtain generator sprays a gas at a direction from an upper lateral side of the reaction chamber to a lower lateral side of the reaction chamber.

6. The apparatus of claim 5, wherein the gas comprises argon.

7. The apparatus of claim 1, further comprising a window in a predetermined portion of the reaction chamber so that the laser beam is transmitted to the inside of the reaction chamber through the window to irradiate the silane gas.

8. The apparatus of claim 1, wherein the laser irradiator comprises:
a laser oscillator for oscillating a pulsed laser beam;
an optical system for enhancing uniformity of the pulsed laser beam; and
a laser power receiver for receiving the laser beam,
wherein the laser oscillator and the optical system are at one external side of the reaction chamber, and the laser power receiver is at another external side of the reaction chamber.

9. The apparatus of claim 1, wherein the reaction chamber comprises a reaction space for deposited polysilicon grains.

10. The apparatus of claim 1, wherein the reaction chamber comprises a vacuum pump connected to the reaction chamber to maintain a vacuum in the reaction chamber.

11. The apparatus of claim 1, wherein the reaction chamber comprises an exhaust apparatus connected to the reaction chamber to exhaust a reaction gas from the reaction chamber.

12. The apparatus of claim 1, wherein the silane gas comprises trichlorosilane (SiHCl₃) or monosilane (SiH₄).

13. The apparatus of claim 1, wherein the gas supplier comprises a gas supplying nozzle inside the reaction chamber, and a gas supplying pipe extending to an exterior of the reaction chamber, the gas supplying pipe being in communication with the gas supplying nozzle.

14. The apparatus of claim 1, wherein the laser irradiator comprises an infrared-ray laser irradiator.

15. The apparatus of claim 14, wherein the infrared-ray laser irradiator comprises a CO₂ laser irradiator.

16. The apparatus of claim 1, wherein the silane gas is irradiated with the laser beam in the reaction chamber by the laser irradiator.

17. The apparatus of claim 16, wherein the laser irradiator irradiates a portion of the reaction chamber between the gas supplier and the polysilicon-grain receiver with the laser beam.

18. The apparatus of claim 17, further comprising a contact area between the laser beam and the silane gas in the portion of the reaction chamber between the gas supplier and the polysilicon-grain receiver.

19. The apparatus of claim 1, wherein the polysilicon-grain receiver is beneath the reaction chamber.

20. The apparatus of claim 1, wherein the laser beam comprises a single wavelength of light, and is a high-energy beam capable of decomposing the silane gas by multi-photon absorption.
